(19) United States
(12) Patent Application Publication
(10) Pub. No.: US 2006/0151493 A1
(43) Pub. Date: Jul. 13, 2006

(54) Method and apparatus for control of chemical reactions

(75) Inventor: Bo Hellman, Uppsala (SE)

Correspondence Address: BIRCH STEWART KOLASCH & BIRCH, PO BOX 747, FALLS CHURCH, VA, 22040-0747, US

(73) Assignee: BIOTAGE AB, Uppsala (SE)

(21) Appl. No.: 10/539,600

(22) PCT Filed: Dec. 18, 2003
(86) PCT No.: PCT/SE03/02009

§ 371 Date: Jan. 6, 2006

Related U.S. Application Data
(60) Provisional application No. 60/433,971, filed on Dec. 18, 2002.

(30) Foreign Application Priority Data
Dec. 18, 2002 (EP) 02102803.0

(51) Int. Cl. H05B 6/62

(52) U.S. Cl. 219/771

(57) ABSTRACT

This invention relates to a method and apparatus for performing microwave assisted chemical reactions, in particular for performing microwave assisted organic synthesis reactions under nearly ideal heating and cooling conditions. The method according to the present invention comprises, supplying substances for a chemical reaction into a reaction chamber, which is adapted to withstand high temperature and pressure, applying microwave heating to initiate the chemical reaction and reach a desired temperature, and cooling the reaction mixture to a desired lower temperature by using adiabatic cooling. The invention also relates to an apparatus for performing the method and use of the method and apparatus for performing organic synthesis reactions.

### TECHNICAL FIELD

This invention relates to a method and apparatus for performing microwave assisted chemical reactions, in particular for performing microwave assisted organic synthesis reactions under nearly ideal heating and cooling conditions.

### BACKGROUND ART

In the field of chemical reactions and particularly of chemical synthesis, there is a high desirability to prepare products with a high purity and yield. Thus, usually each chemical reaction has to be performed under optimum reaction conditions that promote formation of desired reaction product and prevent unwanted side products and/or degradation of the desired final product. Occurrence of side reactions and degradation of the desired product usually takes place during the heating and cooling phase of a chemical reaction, depending on, inter alia, the heating respectively the cooling rate and how uniform the reaction mixture is heated respectively cooled. Too slow heating or cooling rate and/or non-uniform heating or cooling of the reaction mixture often results in products with a lower degree of purity and yield.

Furthermore, it is known that microwave heating enables almost instantaneous heating of materials in a fast and uniform manner. The rapid uniform heating provided by microwave heating is offering higher purity of the resulting product depending, inter alia, that impurities due to side reactions are diminished. However, cooling of the reaction products is still performed using conventional thermal conduction cooling means, e.g., heat exchangers. These conventional cooling means are slow and non-uniform and thus, final products with a lower degree of purity and yield are obtained due to, e.g., degradation of the formed product or side reactions. Accordingly, the gained higher purity and yield of the desired product during the microwave heating step cannot be maintained, but will actually lessen during the cooling step for the reasons set out hereinabove.

Therefore, there is a strong need for a way of obtaining a method and apparatus for performing chemical reactions, where microwave heating is combined with a rapid, uniform cooling, so that both the heating and cooling step take place instantaneously and uniformly, resulting in final products with improved yield and purity.

U.S. Pat. No. 5,932,075 relates to an apparatus for performing batch-wise chemical reactions using microwave energy in a vessel wherein cooling is carried out by means of a heat exchanger means (cold finger) immersed in the contents of the vessel under high temperature and pressure conditions.

U.S. Pat. No. 5,287,397 relates to a method of performing chemical reactions on a continuous basis using microwave heating and cooling the reaction by using a heat exchanger means .

Both U.S. Pat. No. 5,932.075 and U.S. Pat. No. 5,387,397 use traditional heat exchanger cooling means where the cooling rate is much slower than the heating rate achieved by microwave heating and thereby the product yield and purity after the heating step is decreasing during the cooling step.

The object of the present invention is to provide a method and apparatus that solve the above-mentioned problems.

### SUMMARY OF THE INVENTION

The above-mentioned object is achieved by the present invention as defined in the independent claims. Preferred embodiments are set forth in the dependent claims.

An ideal chemical reaction should be heated so that the desired temperature is reached instantaneously and uniformly, and then kept constant for a desired time in order to carry out the reaction to maximum yield is obtained. Subsequently, it should be cooled so that the desired lower temperature is reached instantaneously and uniformly. In order to perform a chemical reaction as close as possible to the ideal heating and cooling profile, the reaction mixture should be heated respectively cooled almost instantaneously and uniformly, to the desired temperature.

Adiabatic cooling as defined herein means the cooling of the contents of a reaction chamber that takes place instantaneously and uniformly; so that no heat (energy) enters or leaves the system and no portion of the contents of the reaction chamber leaves the system (being lost into the surroundings).

The method and the apparatus according to the claimed invention are providing for chemical reactions resulting in products with improved yield and purity. The method according to the present invention comprises:

supplying substances for a chemical reaction into a reaction chamber, which is adapted to withstand high temperature and pressure,

applying microwave heating to initiate the chemical reaction and reach a desired temperature,

instantaneous cooling the reaction mixture to a desired lower temperature by using adiabatic cooling.

The apparatus according to the present invention comprises a reaction chamber having at least an inlet and an outlet and adapted to withstand high temperature and pressure, a microwave heating source for heating a reaction mixture and a cooling means for adiabatic cooling of the reaction mixture comprising a valve, a tubing and an expansion vessel.

### BRIEF DESCRIPTION OF THE DRAWINGS

FIG. 1 shows a heating/cooling profile obtained by conventional heating and cooling methods and apparatuses (dashed line) and an ideal heating/cooling profile which is aimed at by means of the method and apparatus according to the present invention (unbroken line)

FIG. 2 shows an apparatus according to the present invention illustrating a reaction chamber operationally connected to an expansion vessel.

FIG. 3 shows in detail an apparatus according to the present invention illustrating the connection between the reaction chamber and the expansion vessel

FIG. 4 shows in detail an apparatus according to the present invention illustrating the connection between the reaction chamber and the expansion vessel according to another suitable embodiment.

### DETAILED DESCRIPTION OF THE INVENTION

The present invention will now become more fully understood from the detailed description given herein, wherein reference is made to the accompanying drawings.

In the following description of embodiments of the present invention, similar elements in different embodiments are denoted with the same reference numerals.

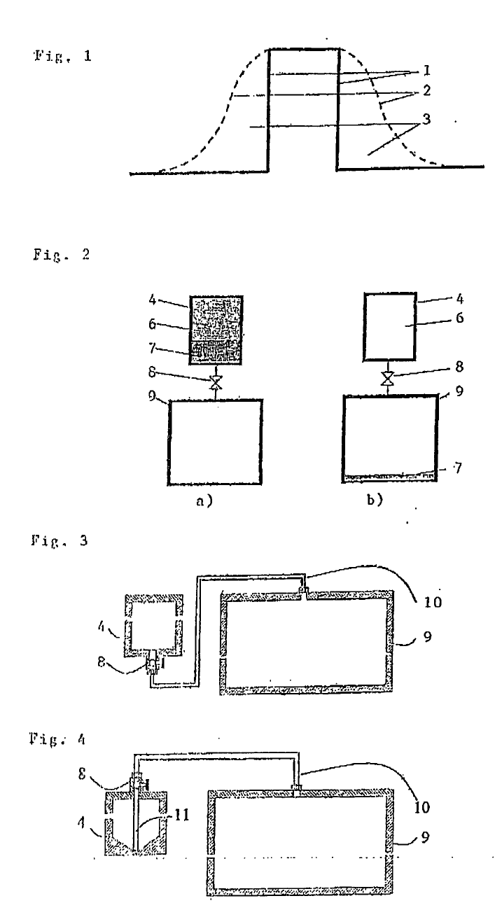

In FIG. 1, an ideal heating and cooling profile 1 respectively a conventional one 2 for a chemical reaction, are illustrated. A chemical reaction performed according to the ideal heating and cooling profile will be heated from an initial temperature Tᵢ to a desired higher temperature T_{d}, instantaneously and uniformly, then if desired be kept for any desired time at T_{d}, and finally cooled to a desired lower temperature T_{c}, also instantaneously and uniformly. Heating and/or cooling of a chemical reaction, taking place within the area 3 (the area between the conventional 2, respectively the ideal 1 heating and cooling profile) will result in final products with a lower purity and yield.

The equipment used for performing microwave heated chemical reactions, usually includes a device having a cavity into which microwaves are guided from a microwave source, typically a magnetron. Such equipment is well known to those skilled in the art and is not, therefore, described in detail herein.

Adiabatic cooling according to the present invention may be obtained by changing the volume of the reaction mixture. This can be achieved by letting the reaction mixture expand into an expansion vessel operationally connected with the reaction chamber.

A schematic illustration of the present invention is shown in FIG. 2. In this embodiment, the reaction chamber 4 is operationally connected with an expansion vessel 9 via a valve 8, in the way that is shown in the figure. The reaction chamber, having a volume V₁, is partly filled with a reaction mixture. The expansion vessel has a volume V₀, which is larger than that of the reaction chamber 4 and, preferably, ambient pressure P₀ and temperature T₀, when valve 8 is closed. While the reaction mixture in the reaction chamber 4 is heated to a temperature T₁ and the pressure is increased to P₁, valve 8 is closed. The reaction mixture in the reaction chamber 4 comprises two phases, a liquid and/or solid phase 7 and a vapor phase 6 due to the prevailing temperature and pressure conditions. When cooling is needed, the valve is opened, causing any liquid or slurry or solid particles at the lower end of the reaction chamber 4, to flow into the expansion vessel 9. The pressure difference, between the reaction chamber 4 and the expansion vessel, forces the reaction mixture to flow into the expansion vessel. During this process the whole reaction mixture is loosing heat under adiabatic cooling conditions. Thermal conduction of the reaction mixture on the walls of the expansion vessel 9 will also contribute to some extent to lower the temperature of the reaction mixture. If the expansion vessel 9 has a volume V₀ that is sufficiently larger than the volume V₁ of the reaction chamber 4 the final temparture and pressure in the expansion vessel 9, T₂ and P₂ respectively, will be slightly higher than that of the initial T₀ and P₀ respectively.

FIG. 3 illustrates in more detail an embodiment of the apparatus according to the invention wherein the reactor chamber 4 and the expansion vessel 9 are connected by means of a valve 8, e.g. a ball valve, adjacent to the bottom of the reaction chamber 4, and a tubing 10 between the valve 8 and the expansion vessel 9.

FIG. 4 illustrates another embodiment of the apparatus acccording to the invention wherein the valve 8, eg. a ball valve, is placed adjacent to the top of the reaction chamber 4 and wherein a tubing 11 goes from the valve 8 to the bottom of the reaction chamber 4, which bottom is shaped so as to minimize the dead volume between the tubing 11 and the lowest part of the reactor bottom. The valve 8 is connected with the expansion vessel 9 by a tubing 10.

The tubing 10 may have a length of from 0 to about 1 meter.

The achieved cooling rate will depend on the reaction volume, reagents, solvents and reactants used and temperature conditions, but will be significantly faster than using conventional cooling techniques. As an example 200 ml of water has been shown to cool from 200° C. to 40° C. in seconds rather than in minutes or hours as is the case with conventional cooling means.

The pressure used in the present invention may be up to 1000 bar. The temperature used may be up to 500° C. The time intervals used for the cooling process may vary from parts of seconds to a few minutes.

The volume ratio between the volume of the expansion vessel (9) and the volume of the reaction chamber (4) may be between 0,25 and 1000, suitably between 1 and 500, preferably between 10 and 100.

The apparatus according to the present invention may also comprise more than one expansion vessel (9) operationally connected to the reaction chamber (4).

The apparatus according to the present invention may also comprise control means for control various parameters that are important, such as microwave input power, pressure, temperature, etc. in order, for example, to obtain the desired temperature profile for a certain chemical reaction. These control means may be any known control means suitable for use with the present invention.

The invention provides for chemical products with improved purity and thereby simplifies the subsequent purification process.

The method and the apparatus according to the present invention can be utilised for performing chemical reactions on a batch as well as on a continuous basis.

The method and the apparatus according to the present invention are suitable for performing chemical reactions and particularly chemical synthesis reactions, in laboratory scale as well as in large industrial scale. They are especially suitable for performing chemical reactions in large scale.

Furthermore, the method and apparatus of the invention is particularly suitable for organic synthesis reactions and is especially suitable for the production of labile molecules.

A further unexpected advantage achieved when performing chemical reactions by the method and apparatus according to the present invention is that when the final product is a crystallizable substance crystals are formed exclusively in the expansion vessel i.e. without any formation of crystals in the tubing due to the instantaneous cooling of the whole reaction mixture. In this case the volume ratio between the volume of the expansion vessel and the volume of the reaction chamber is at least 1.

The present invention also relates to the use of the above-described method and apparatus for performing organic chemical synthesis reactions. Chemical reactions that can be carried out by using the hereinabove described method and apparatus are, for example, oxidation, nucleophilic substitution, addition, esterification, transesterification, acetalisation, transketalisation, amidation, hydrolyses, isomerisation, condensation, decarboxylation and elimination.

The invention is illustrated by means of the following example but is not to be limited thereby.

Sarcosin (5.35 g, 60.05 mmol) and phenyl isothiocyanate (9.49 g, 70.2 mmol) were dissolved i ethanol (120 ml) and placed in a microwave batch reactor vessel. The reaction mixture was irradiated for 2 minutes at 180° C. Using an adiabatic cooling means according to the present invention the product was transferred completely via a 3 mm tubing from the reactor vessel with a volume of 350 ml to an expansion vessel with a volume of 4000 ml and cooled to below 40° C. within 30 seconds. Crystallization of desired product occurred in the expansion vessel, no crystallization could be seen in the connecting tubing nor in the completely emptied reactor vessel.

The above disclosure of the invention has been presented for illustrative purposes without limiting the invention in any way . Various alternatives and modifications of the method and apparatus described herein will be obvious to one of ordinary skill in the art. The scope of the invention is defined by the claims.

1. A method of performing chemical reactions comprising:
supplying substances for a chemical reaction into a reaction chamber(4), which is adapted to withstand high temperature and pressure,
applying microwave heating to initiate the chemical reaction and reach a desired temperature and,
instantaneous cooling the reaction mixture to a desired lower temperature by using adiabatic cooling.

2. A method according to claim 1, further comprising
maintaining the desired temperature substantially constant for a desired time to carry out the chemical reaction.

3. A method according to claim 1 or 2, wherein the cooling is obtained by increasing the volume of the reaction mixture by letting it expand into an expansion vessel 9.

4. An apparatus for performing the method according to claim 1, comprising a reaction chamber (4) having at least an inlet and an outlet and adapted to withstand high temperature and pressure, a microwave heating source for heating a reaction mixture and a cooling means for adiabatic cooling of the reaction mixture comprising a valve (8), a tubing (10) and an expansion vessel (9).

5. An apparatus according to claim 4, wherein the volume ratio between the volume of the expansion vessel (9) and the volume of the action chamber (4) is between 1 to 500.

6. An apparatus according to claim 4 or 5, wherein it further comprises more than one expansion vessel(9) operationally connected to the reaction chamber (4).

7. An apparatus according to claim 4, wherein the bottom end of tubing (11) is positioned at the lower end of the reaction chamber (4) at or below the liquid phase level of the reaction mixture.

8. Use of a method according to claim 1 for performing organic synthesis reactions.

9. Use of an apparatus according to claim 4 for performing organic synthesis reactions.
